(19) United States
(12) Patent Application Publication
(10) Pub. No.: US 2024/0204376 A1
(43) Pub. Date: Jun. 20, 2024

(54) BATTERY

(71) Applicant: Panasonic Intellectual Property Management Co., Ltd., Osaka (JP)

(72) Inventor: MAKOTO FUJINO, Osaka (JP)

(21) Appl. No.: 18/504,116

(22) Filed: Nov. 7, 2023

Related U.S. Application Data
(63) Continuation of application No. PCT/JP2022/010444, filed on Mar. 10, 2022.

(30) Foreign Application Priority Data
May 27, 2021 (JP) 2021-088880

(51) Int. Cl. H01M 50/569; H01M 50/209; H01M 50/213; H01M 50/486; H01M 50/51; H01M 50/512

(52) U.S. Cl. CPC H01M 50/569; H01M 50/209; H01M 50/213; H01M 50/486; H01M 50/51; H01M 50/512

(57) ABSTRACT

A battery includes: a solid-state battery section having a structure in which a plurality of power generating elements are laminated, each of which has a first electrode layer, a second electrode layer, and a first solid electrolyte layer; and a structure including a second solid electrolyte layer in contact with the power generating element so as not to be in contact with more than or equal to two power generating elements on a side surface of the solid-state battery section, reference electrode section facing the side surface of the solid-state battery section across the second solid electrolyte layer and including a reference electrode in contact with the second solid electrolyte layer, and an insulating member which is disposed so as to surround the second solid electrolyte layer in plan view of the side surface of the solid-state battery section and covers the side surface of the solid-state battery section.

### BACKGROUND

### 1. Technical Field

The present disclosure relates to a battery.

### 2. Description of the Related Art

A solid-state battery that uses a flame-retardant solid electrolyte instead of an electrolyte solution containing a flammable organic solvent for use in a battery in the related art such as a non-aqueous electrolyte solution type lithium-ion secondary battery holds high superiority in basic performance for safety. Thus, having high potential in terms of cost and energy density, such as simplification of a safety device in product development, the solid-state battery is seen as a promising next-generation battery and development competition thereof is accelerating.

Particularly, the solid-state battery is expected to be useful as a compact battery that can output a high voltage, since it is relatively easy to form a battery configuration (hereinafter referred to as a bipolar battery) in which power generating elements having a positive electrode layer and a negative electrode layer are laminated and connected in series. The solid-state battery is also expected to be useful as a compact, high-capacity battery, since it is also relatively easy to form a battery configuration in which power generating elements are laminated and connected in parallel.

In actual use of the battery, when electrical characteristics can be measured, such as the potential of each electrode such as a positive electrode and a negative electrode during operation, it is possible to know the states of the electrodes more accurately and to perform more appropriate battery control based on the measured values. This also makes it possible to improve performance such as maintenance of high-performance characteristics, safety, cycle characteristics, and storage characteristics, for example.

As a method for investigating the potential and electrochemical behavior of each single electrode, known is a three-electrode measurement method using a reference electrode. For example, “Q & A de Rikaisuru Denkikagaku no Sokutei Hou (Understanding of Electrochemical Measurement Method with Q & A)” edited by The Electrochemical Society of Japan, published by Mimizuku-sha in December 2009, p. 10 describes battery configurations of solid-state batteries having various structures in which the three-electrode measurement is possible. In addition, Japanese Unexamined Patent Application Publication No. 2013-20915 discloses a solid-state battery in which a positive electrode current collector, a positive electrode, a solid electrolyte layer, a negative electrode, and a negative electrode current collector are laminated and a third electrode is provided as a reference electrode in contact with a solid electrolyte section provided being connected with the same width as the length of the side surface of the solid electrolyte layer or the length of the side surfaces of the positive electrode, the solid electrolyte layer, and the negative electrode.

### SUMMARY

To obtain an all-solid-state battery with high performance and high energy density, it is common that the positive and negative electrodes and the solid electrolyte layer are thinned and laminated. In order to construct such an all-solid-state battery in which three-electrode measurement is possible, unlike a solution-based battery in which electrochemical contact is formed only by immersion in an electrolyte solution, the solid electrolyte layer is required to be electrochemically bonded and contacted between a cell section and a reference electrode.

In particular, in a battery having power generation elements laminated therein, in order to improve measurement accuracy and to suppress the occurrence of short-circuiting, it is required to arrange a reference electrode section including a reference electrode and a solid electrolyte layer for the reference electrode so that power generating elements adjacent to each other in the laminating direction are not connected by the solid electrolyte layer for the reference electrode. In addition, in a battery in which positive and negative electrodes and a solid electrolyte layer are thinned and laminated, the reference electrode section is also required to be thinned. In the structure of the related art, the reference electrode section may be easily damaged. There is also a demand for improved reliability in a battery in which three-electrode measurement is possible.

One non-limiting and exemplary embodiment provides a highly reliable battery in which electrical characteristics of electrodes can be measured.

In one general aspect, the techniques disclosed here feature a battery including: a solid-state battery section having a structure in which a plurality of power generating elements are laminated, each of which has a first electrode layer, a second electrode layer, and a first solid electrolyte layer positioned between the first electrode layer and the second electrode layer; and a structure including a second solid electrolyte layer in contact with the power generating element so as not to be in contact with more than or equal to two power generating elements of the plurality of power generating elements on a side surface of the solid-state battery section, at least one reference electrode section facing the side surface of the solid-state battery section across the second solid electrolyte layer and including a reference electrode in contact with the second solid electrolyte layer, and an insulating member which is disposed so as to surround the second solid electrolyte layer in plan view of the side surface of the solid-state battery section and covers the side surface of the solid-state battery section.

According to the present disclosure, it is possible to provide a highly reliable battery in which electrical characteristics of electrodes can be measured.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view showing a schematic configuration of a battery according to an embodiment;

FIG. 2A is a side view showing the schematic configuration of the battery according to the embodiment;

FIG. 2B is a side view showing a state where a reference electrode current collector is removed from the battery shown in FIG. 2A;

FIG. 3A is a diagram for explaining a method for manufacturing a battery according to an embodiment;

FIG. 3B is a diagram for explaining the method for manufacturing a battery according to the embodiment;

FIG. 3C is a diagram for explaining the method for manufacturing a battery according to the embodiment;

FIG. 3D is a diagram for explaining the method for manufacturing a battery according to the embodiment;

FIG. 4 is a diagram for explaining a method for measuring electrical characteristics of the battery according to the embodiment;

FIG. 5A is a side view showing a schematic configuration of a battery according to modified example 1 of the embodiment;

FIG. 5B is a side view showing a state where a reference electrode current collector is removed from the battery shown in FIG. 5A;

FIG. 6 is a cross-sectional view showing a schematic configuration of a battery according to modified example 2 of the embodiment;

FIG. 7 is a cross-sectional view showing a schematic configuration of a battery according to modified example 3 of the embodiment; and

FIG. 8 is a cross-sectional view showing a schematic configuration of a battery according to modified example 4 of the embodiment.

### DETAILED DESCRIPTIONS

### Outline of Present Disclosure

An aspect of the present disclosure is outlined as follows.

A battery according to the aspect of the present disclosure includes a solid-state battery section having a structure in which a plurality of power generating elements are laminated, each of which has a first electrode layer, a second electrode layer, and a first solid electrolyte layer positioned between the first electrode layer and the second electrode layer; and a structure including a second solid electrolyte layer in contact with the power generating element so as not to be in contact with more than or equal to two power generating elements of the plurality of power generating elements on a side surface of the solid-state battery section, at least one reference electrode section facing the side surface of the solid-state battery section across the second solid electrolyte layer and including a reference electrode in contact with the second solid electrolyte layer, and an insulating member which is disposed so as to surround the second solid electrolyte layer in plan view of the side surface of the solid-state battery section and covers the side surface of the solid-state battery section.

Thus, the insulating member arranged so as to surround the second solid electrolyte layer can increase mechanical strength of the reference electrode section for measuring electrical characteristics of each electrode layer. In addition, the insulating member covers the side surface of the solid-state battery section while surrounding the second solid electrolyte layer. Thus, electrical and ion conductive short-circuiting can be suppressed between the reference electrode section and the solid-state battery section and between the plurality of power generating elements in the solid-state battery section. Therefore, the electrical characteristics of the electrodes can be measured, and a highly reliable battery can be realized.

For example, the at least one reference electrode section may include a plurality of reference electrode sections, a plurality of second solid electrolyte layers, which are the second solid electrolyte layers included in the plurality of reference electrode sections, respectively, may be each in contact with different power generating elements among the plurality of power generating elements, and the insulating member may be arranged so as to surround each of the plurality of second solid electrolyte layers in plan view of the side surface of the solid-state battery section.

Thus, the electrical characteristics of the electrode layers in the plurality of power generating elements can be individually measured.

For example, the insulating member may be continuous, which is arranged so as to surround each of the plurality of second solid electrolyte layers.

Thus, since the insulating member is integrally formed, for example, the mechanical strength of the structure can be increased.

For example, the plurality of second solid electrolyte layers may include two second solid electrolyte layers in contact with each of adjacent power generating elements among the plurality of power generating elements, and the two second solid electrolyte layers may not overlap when viewed from the laminating direction of the solid-state battery section.

Thus, since the distance between the two second solid electrolyte layers can be increased, contact between the two second solid electrolyte layers can be suppressed.

For example, the plurality of second solid electrolyte layers may have portions, respectively, that do not overlap with each other when viewed along the laminating direction of the solid-state battery section.

Thus, even when a conductive member or the like is extended in the laminating direction of the solid-state battery section from each reference electrode section along the surface of the insulating member, the conductive member or the like does not collide with other reference electrode sections. Accordingly, a structure of a connector for electrical connection with each reference electrode section can be simplified.

For example, the number of the plurality of second solid electrolyte layers may be more than or equal to four, and the plurality of second solid electrolyte layers may be arranged so as to form a plurality of rows extending along a direction not orthogonal to the laminating direction of the solid-state battery section on the side surface of the solid-state battery section.

Thus, the plurality of second solid electrolyte layers are dispersed into a plurality of rows and arranged in a certain pattern. Therefore, the plurality of second solid electrolyte layers can be compactly arranged while increasing the mechanical strength of the structure.

For example, the plurality of power generating elements may be electrically connected in series and laminated.

Thus, in a series-laminated battery capable of outputting a high voltage, the electrical characteristics of the electrodes can be measured, and the reliability can be improved.

For example, the plurality of power generating elements may be electrically connected in parallel and laminated.

Thus, in a high-capacity parallel-laminated battery, the electrical characteristics of the electrodes can be measured, and the reliability can be improved.

For example, the plurality of power generating elements may be electrically connected in parallel and laminated, and the reference electrodes may be more than or equal to two of the plurality of reference electrode sections are connected. For example, the plurality of power generating elements may be electrically connected in parallel and laminated, the plurality of reference electrode sections each further may include a reference electrode current collector in contact with the reference electrode, and at least one of the reference electrodes in more than or equal to two of the plurality of reference electrode sections and the reference electrode current collectors in more than or equal to two reference electrode sections may be connected.

Thus, the structure can be simplified, and the mechanical strength of the structure can be increased.

For example, the insulating member may contain insulating resin.

The side surface of the solid-state battery section often has fine unevenness derived from the material of each layer in the power generating element. A bonding anchor effect between such unevenness and the insulating resin of the insulating member can improve bondability between the solid-state battery section and the structure. Therefore, the mechanical strength of the battery is enhanced, and the second solid electrolyte layer is strongly protected by the insulating member. Thus, the reliability of the battery can be improved.

For example, in plan view of the side surface of the solid-state battery section, the structure may not protrude beyond both ends of the solid-state battery section in the laminating direction of the solid-state battery section.

Thus, even when the solid-state battery section is pressurized in the laminating direction in order to maintain the performance of the power generating element, the structure hardly interferes with the pressurization, and deterioration in battery characteristics of the solid-state battery section can be suppressed.

For example, a length of the structure in the laminating direction of the solid-state battery section may be smaller than a length of the solid-state battery section in the laminating direction of the solid-state battery section.

Thus, in the laminating direction of the solid-state battery section, the structure is located on the inner side than the solid-state battery section. Therefore, even when the solid-state battery section is compressed in the laminating direction by the pressurization of the solid-state battery section in the laminating direction, the structure is less likely to hinder the compression of the solid-state battery section. Therefore, the battery characteristics of the solid-state battery section can be enhanced.

Hereinafter, embodiments will be specifically described with reference to the drawings.

The embodiments described below all illustrate comprehensive or specific examples. The numerals, shapes, materials, constituent elements, the arrangement and connections of the constituent elements, manufacturing steps, order of the manufacturing steps, and the like discussed in the following embodiments are only exemplary and are not construed to limit the present disclosure. Among the constituent elements in the following embodiments, constituent elements not described in an independent claim will be described as arbitrary constituent elements.

The drawings are schematic and not necessarily to scale. Therefore, for example, scales and the like do not necessarily match in each drawing. In addition, in each drawing, substantially the same configurations are denoted by the same reference numerals to eliminate or simplify overlapped description.

In the present specification, terms indicating the relationship between elements such as parallel and perpendicular, terms indicating the shape of elements such as a rectangle and a circle, and numerical ranges are expressions including substantially the same ranges, for example, differences of about several percent, rather than expressions indicating strict meanings only.

In the present specification and drawings, an x-axis, a y-axis, and a z-axis represent three axes of a three-dimensional orthogonal coordinate system. The x-axis and the y-axis correspond to directions parallel to principal surfaces of current collectors and each layer included in a solid-state battery section, respectively. The z-axis corresponds to a laminating direction of a plurality of power generating elements included in the solid-state battery section and to a laminating direction of each layer included in the power generating element. Also, the “laminating direction” is a direction in which the layers are laminated in the solid-state battery section unless otherwise specified, and corresponds to a direction normal to the principal surfaces of the current collectors and each layer included in the solid-state battery section.

Further, a “plan view” of a certain surface” means a view of the certain surface as seen from the front.

Also, in the present specification, the terms “above” and “below” in a battery configuration do not refer to upward (vertically upward) and downward (vertically downward) directions in absolute spatial recognition, but are rather used as terms defined by a relative positional relationship based on a laminating order in a laminated structure. In addition, the terms “above” and “below” are applied not only to a case where two constituent elements are arranged in close contact with each other but also to a case where two constituent elements are spaced apart from each other with another constituent element between the two constituent elements.

### EMBODIMENT

First, a battery according to an embodiment will be described.

### Battery Configuration

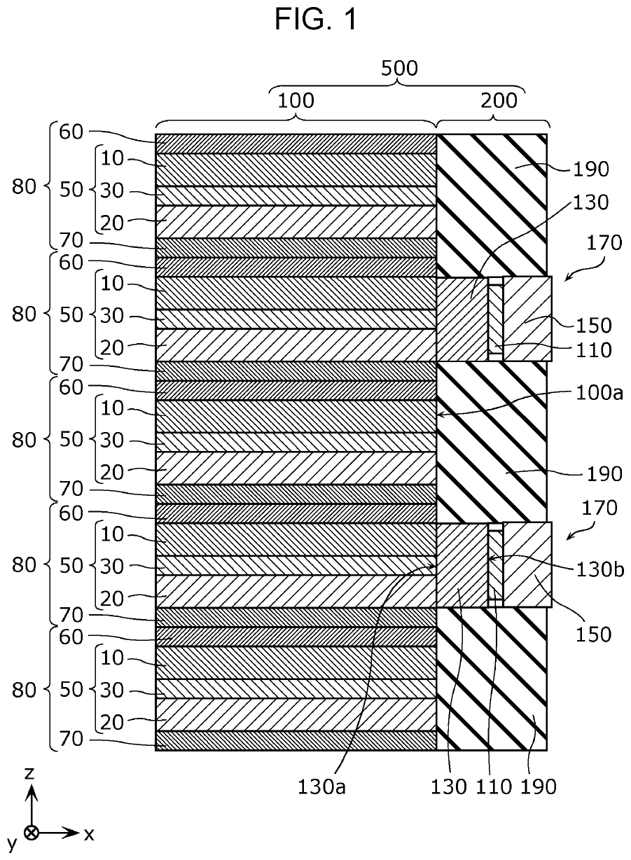

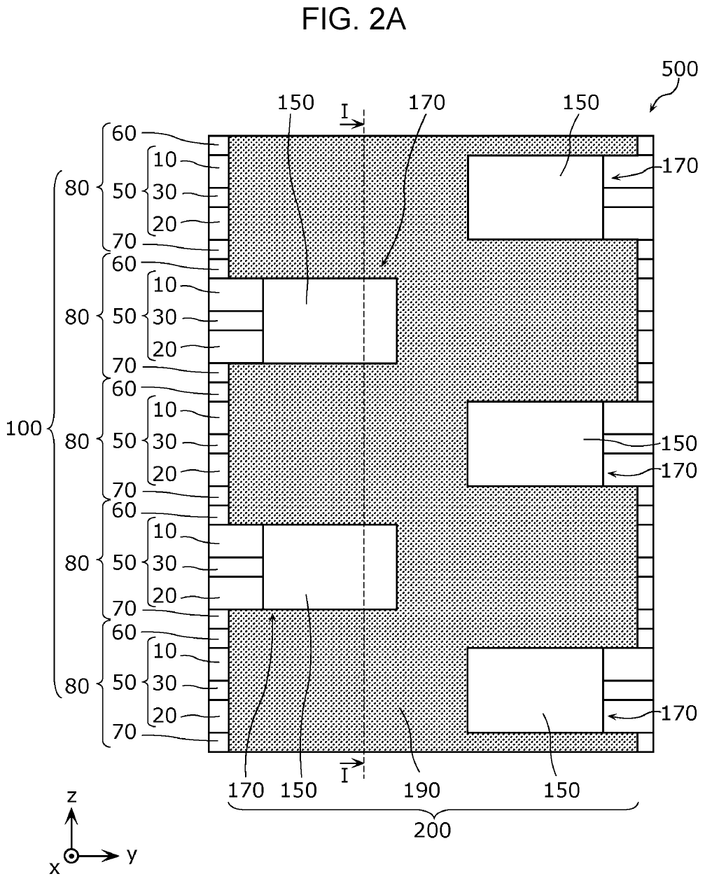

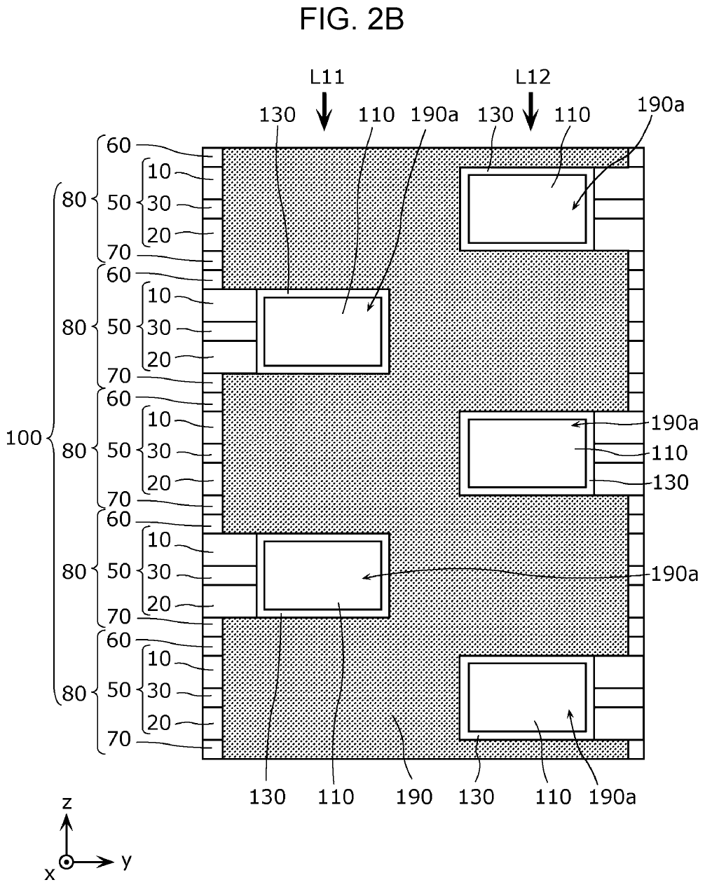

First, a configuration of the battery according to this embodiment will be described. FIG. 1 is a cross-sectional view showing a schematic configuration of a battery 500 according to this embodiment. FIG. 2A is a side view showing the schematic configuration of the battery 500 according to this embodiment. FIG. 2A is a plan view of a side surface 100a of a solid-state battery section 100. FIG. 2B is a side view showing a state where a reference electrode current collector 150 is removed from the battery 500 shown in FIG. 2A. Note that FIG. 1 shows a cross section taken along the line I-I of FIG. 2A. In FIGS. 2A and 2B, an insulating member 190 has a dot pattern in order to make it easier to recognize a region where the insulating member 190 is formed, but this is not intended to mean that the actual insulating member 190 has the dot pattern.

As shown in FIGS. 1 and 2A, the battery 500 includes the solid-state battery section 100 having a plurality of power generating elements 50 and a structure 200 having a reference electrode section 170 and an insulating member 190. The battery 500 is an all-solid-state battery, for example. The battery 500 is a coin-type, laminate-type, cylindrical or square battery, for example.

The solid-state battery section 100 has a plurality of power generating elements 50, positive electrode current collectors 60, and negative electrode current collectors 70. The solid-state battery section 100 has a structure in which the plurality of power generating elements 50 are laminated. In the example shown in FIGS. 1 and 2A, the solid-state battery section 100 has five power generating elements 50, but the number of the power generating elements 50 is not limited, and the solid-state battery section 100 may have two or more power generating elements 50. The solid-state battery section 100 may also have four or more power generating elements 50. The shape of the solid-state battery section 100 is, for example, a rectangular parallelepiped shape, a polygonal prism shape, a cylindrical shape, or the like.

The side surface 100a of the solid-state battery section 100 is in contact with the structure 200. To be more specific, the side surface 100a is in contact with a second solid electrolyte layer 130 and the insulating member 190. The side surfaces of the solid-state battery section 100 and each component of the solid-state battery section 100 are surfaces that connect two principal surfaces facing each other in the solid-state battery section 100 and each component of the solid-state battery section 100, and are parallel to a laminating direction, for example. Note that the side surface 100a may be inclined with respect to the laminating direction.

The plurality of power generating elements 50 are electrically connected in series and laminated. Thus, the battery 500 capable of outputting a high voltage can be realized. Among the plurality of power generating elements 50, the power generating elements 50 adjacent to each other are laminated with the positive electrode current collector 60 and the negative electrode current collector 70 interposed therebetween. The plurality of power generating elements 50 are laminated such that the positive electrode layer 10 in one of the adjacent power generating elements 50 and the negative electrode layer 20 in the other power generating element 50 are electrically connected via the current collectors.

The power generating element 50 includes the positive electrode layer 10, the negative electrode layer 20 arranged opposite to the positive electrode layer 10, and a first solid electrolyte layer 30 positioned between the positive electrode layer 10 and the negative electrode layer 20. The positive electrode layer 10 is an example of a first electrode layer, and the negative electrode layer 20 is an example of a second electrode layer. In the power generating element 50, the positive electrode layer 10, the first solid electrolyte layer 30, and the negative electrode layer 20 are laminated in this order. The shape of the power generating element 50 is, for example, a rectangular parallelepiped shape, a polygonal prism shape, a cylindrical shape, or the like.

The plurality of power generating elements 50 are laminated such that the layers of all the power generating elements 50 are arranged in the same direction. Therefore, the positive electrode layer 10 in one of the adjacent power generating elements 50 and the negative electrode layer 20 in the other power generating element face each other without the first solid electrolyte layer 30 interposed therebetween.

In each of the plurality of power generating elements 50, the positive electrode current collector 60 is laminated on the principal surface of the positive electrode layer 10 opposite to the first solid electrolyte layer 30, and the negative electrode current collector 70 is laminated on the principal surface of the negative electrode layer 20 opposite to the first solid electrolyte layer 30. The positive electrode current collector 60 and the negative electrode current collector 70 are arranged between the adjacent power generating elements 50. Thus, the positive electrode layer 10 in one of the adjacent power generating elements 50 and the negative electrode layer 20 in the other power generating element are electrically connected. Note that only one of the positive electrode current collector 60 and the negative electrode current collector 70 may be arranged between the adjacent power generating elements 50. That is, the positive electrode layer 10 may be laminated on one principal surface of one positive electrode current collector 60 or one negative electrode current collector 70, and the negative electrode layer 20 may be laminated on the other principal surface.

The positive electrode current collector 60, the negative electrode current collector 70, and the power generating element 50 positioned between the positive electrode current collector 60 and the negative electrode current collector 70 constitute a unit battery cell 80. That is, the unit battery cell 80 has the positive electrode current collector 60, the negative electrode current collector 70, and the power generating element 50. Therefore, the solid-state battery section 100 has a structure in which a plurality of unit battery cells 80 are laminated such that the electrodes of different polarities in the adjacent unit battery cells 80 are connected to each other. Thus, the plurality of unit battery cells 80 are electrically connected in series and laminated.

The positive electrode layer 10 is positioned between the positive electrode current collector 60 and the first solid electrolyte layer 30 and is in contact with the positive electrode current collector 60 and the first solid electrolyte layer 30.

The positive electrode layer 10 contains at least a positive electrode active material. As a material for the positive electrode layer 10, in addition to the positive electrode active material, a positive electrode mixture containing at least one of a solid electrolyte, a conductive assistant, and a binder material may be used as necessary.

The positive electrode active material may be a known material capable of occluding and releasing (inserting and desorbing or dissolving and depositing) metal ions such as lithium ions, sodium ions, magnesium ions, potassium ions, calcium ions, and copper ions.

Examples of the positive electrode active material include a transition metal oxide containing lithium, a transition metal oxide not containing lithium, a transition metal fluoride, a polyanion material, a fluorinated polyanion material, a transition metal sulfide, a transition metal oxyfluoride, a transition metal oxysulfide, a transition metal oxynitride, and the like. When the lithium-containing transition metal oxide is used as the positive electrode active material, the manufacturing cost of the battery can be reduced and an average discharge voltage of the battery can be increased.

When the positive electrode active material is a material capable of desorbing and inserting lithium ions, lithium cobaltate composite oxide (LCO), lithium nickelate composite oxide (LNO), lithium manganate composite oxide (LMO), lithium-manganese-nickel composite oxide (LMNO), lithium-manganese-cobalt composite oxide (LMCO), lithium-nickel-cobalt composite oxide (LNCO), lithium-nickel-manganese-cobalt composite oxide (LNMCO) or the like is used, for example. Specific examples of the positive electrode active material include LiCoO₂, LiMn₂O₄, Li₂NiMn₃O₈, LiVO₂, LiCrO₂, LiFePO₄, LiCoPO₄, LiNiO₂, LiNi_{1/3}CO_{1/3}Mn_{1/3}O₂, LiNiₓMn_{y}Al_{z}O₂, LiNiₓCo_{y}Mn_{z}, LiNiₓCo_{y}Al_{z}, and the like.

As the solid electrolyte, a known material may be used that conducts metal ions such as lithium ions, sodium ions, magnesium ions, potassium ions, calcium ions, copper ions or silver ions, or protons or the like. As the solid electrolyte, a solid electrolyte material is used, such as sulfide solid electrolyte, halogen-based solid electrolyte, oxide solid electrolyte, and polymer solid electrolyte, for example.

When the sulfide solid electrolyte is made of a material capable of conducting lithium ions, a composite (Li₂S—P₂S₅) consisting of lithium sulfide (Li₂S) and phosphorus pentasulfide (P₂S₅) is used, for example. Examples of the sulfide solid electrolyte include sulfides such as Li₂S—P₂S₅, Li₂S—P₂S₅—LiBH₄, Li₇P₃S₁₁, Li₂S—SiS₂, Li₂S—SiS₂—Li₃PO₄, Li₂S—SiS₂—Li₄SiO₄, Li₂S—B₂S₃, Li₂S—GeS₂, Li₆PS₅Cl, LiSiPSCl, and a sulfide containing Li₃N or Li₃N(H). As the sulfide solid electrolyte, a sulfide obtained by adding at least one of Li₃N, LiCl, LiBr, LiI, Li₃PO₄, and Li₄SiO₄ as an additive to the above sulfide may be used. Other specific examples of the sulfide solid electrolytes include Li₁₀GeP₂S₁₂ (LGPS), Na₃Zr₂ (SiO₄)₂PO₄ (NASICON), and the like.

When the oxide solid electrolyte is made of a material capable of conducting lithium ions, LizLa₃Zr₂O₁₂ (LLZ), Li_{1.3}Al_{0.3}Ti_{1.7} (PO₄)₃(LATP), (La,Li)TiO₃(LLTO) or the like is used, for example.

The halogen-based solid electrolyte is a solid electrolyte containing a halide. The halide is, for example, a compound consisting of Li, M′ and X′. M′ is at least one element selected from the group consisting of a metal element other than Li and a metalloid element. X′ is at least one element selected from the group consisting of F, Cl. Br, and I. The “metal elements” represent all elements (excluding hydrogen) found in Groups 1 to 12 of the periodic table and all elements (excluding B, Si, Ge, As, Sb, Te, C, N, P, O, S, and Se) found in Groups 13 to 16 of the periodic table. The “metalloid elements” represent B, Si, Ge, As, Sb, and Te. For example, M′ may contain Y (yttrium). The halide containing Y may be Li₃YCl₆ and Li₃YBr₆.

Examples of other halides include Li₂MgX′₄, Li₂FeX′₄, Li(Al,Ga,In)X′₄, Li₃(Al,Ga,In)X′₆, LiOX′, and LiX′. To be more specific, examples of the halide include Li₃InBr₆, Li₃InCl₆, Li₂FeCl₄, Li₂CrCl₄, Li₃OCl, and LiI.

The polymer solid electrolyte is not particularly limited as long as the solid electrolyte contains an ion-conductive polymer material. Examples of the ion-conductive polymer material include polyether, polyether derivative, polyester, polyimine, and the like.

Besides the solid electrolyte material described above, a thin-film solid electrolyte material such as lithium phosphorus oxynitride (LIPON) may be used as the solid electrolyte.

In the positive electrode layer 10, the volume ratio of the positive electrode active material to the sum of the volume of the positive electrode active material and the volume of the solid electrolyte is, for example, greater than or equal to 30% and less than or equal to 95%. Also, the volume ratio of the solid electrolyte to the sum of the volume of the positive electrode active material and the volume of the solid electrolyte is, for example, greater than or equal to 5% and less than or equal to 70%. When the amount of the positive electrode active material and the amount of the solid electrolyte are in such a volume ratio, it is made easier to ensure a sufficient energy density of the battery 500 and to operate the battery 500 at high output.

As the binder material, the same material as that of a binder used for general solid-state batteries can be used. Examples of the binder material include polyvinylidene fluoride, polytetrafluoroethylene, polyethylene, polypropylene, aramid resin, polyamide, polyimide, polyamideimide, polyacrylonitrile, polyaryl acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, carboxymethylcellulose, polyaniline, polythiophene-styrene-butadiene rubber, polyacrylate, and the like. Alternatively, as the binder material, a copolymer of two or more materials selected from the group consisting of tetrafluoroethylene, hexafluoro ethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene may be used.

Examples of the conductive assistant include graphites such as natural graphite and artificial graphite, carbon blacks such as acetylene black, furnace black, and Ketjen Black (registered trademark), conductive fibers such as VGCF, carbon nanotube, carbon nanofiber, fullerene, carbon fiber, and metal fiber, metal powders such as carbon fluoride and aluminum powder, conductive whiskers such as zinc oxide whisker and potassium titanate whisker, conductive metal oxides such as titanium oxide, conductive polymer compounds such as polyaniline, polypyrrole, and polythiophene, and the like.

The shape of the conductive assistant is, for example, acicular, scale-like, spherical, or oval. The conductive assistant may be particles.

The positive electrode layer 10 has a thickness of, for example, greater than or equal to 10 μm and less than or equal to 500 μm. When the thickness of the positive electrode layer 10 is within such a range, it becomes easier to ensure a sufficient energy density of the battery 500 and to operate the battery 500 at high output. In the present specification, the thickness of each constituent element of the solid-state battery section 100 is the length of each constituent element in the laminating direction.

Examples of a method of forming the positive electrode layer 10 include a method wherein a powdered positive electrode mixture is subjected to uniaxial compression molding, and the like. The first solid electrolyte layer 30 may be formed by applying and drying a paste-like paint containing a positive electrode mixture kneaded together with a solvent on a substrate, the first solid electrolyte layer 30, the positive electrode current collector 60 or the like.

The negative electrode layer 20 is positioned between the negative electrode current collector 70 and the first solid electrolyte layer 30 and is in contact with the negative electrode current collector 70 and the first solid electrolyte layer 30.

The negative electrode layer 20 contains at least a negative electrode active material. As a material for the negative electrode layer 20, in addition to the negative electrode active material, a negative electrode mixture containing at least one of a solid electrolyte, a conductive assistant, and a binder material may be used as necessary.

The negative electrode active material may be a known material capable of occluding and releasing (inserting and desorbing or dissolving and depositing) metal ions such as lithium ions, sodium ions, magnesium ions, potassium ions, calcium ions, and copper ions. Examples of the negative electrode active material include a metal material, a carbon material, an oxide, a nitride, a tin compound, a silicon compound, and the like.

When the negative electrode active material is a material capable of desorbing and inserting lithium ions, a carbon material such as natural graphite, artificial graphite, graphite carbon fiber or resin-heat-treated carbon, metal lithium, lithium alloy, oxides of lithium and transition metal elements, and the like are used, for example. Examples of metal used in the lithium alloy include indium, aluminum, silicon, germanium, tin, zinc, and the like. Specific examples of the oxides of lithium and transition metal elements include Li₄Ti₅O₁₂, LiₓSiO, and the like.

As the solid electrolyte of the negative electrode layer 20, the solid electrolyte material described above can be used. As the conductive assistant for the negative electrode layer 20, the conductive assistant described above can be used.

As the binder material for the negative electrode layer 20, the binder material described above can be used.

In the negative electrode layer 20, the volume ratio of the negative electrode active material to the sum of the volume of the negative electrode active material and the volume of the solid electrolyte is, for example, greater than or equal to 30% and less than or equal to 95%. Also, the volume ratio of the solid electrolyte to the sum of the volume of the negative electrode active material and the volume of the solid electrolyte is, for example, greater than or equal to 5% and less than or equal to 70%. When the amount of the negative electrode active material particles and the amount of the solid electrolyte are in such a volume ratio, the energy density of the battery 500 can be sufficiently secured, and the battery 500 can be easily operated at high output.

The negative electrode layer 20 has a thickness of, for example, greater than or equal to 10 μm and less than or equal to 500 μm. When the thickness of the negative electrode layer 20 is within such a range, it becomes easier to ensure a sufficient energy density of the battery 500 and to operate the battery 500 at high output.

Examples of a method of forming the negative electrode layer 20 include a method wherein a powdered negative electrode mixture is subjected to uniaxial compression molding, and the like. The negative electrode layer 20 may be formed by applying and drying a paste-like paint containing a negative electrode mixture kneaded together with a solvent on a substrate, the first solid electrolyte layer 30, the negative electrode current collector 70 or the like.

The first solid electrolyte layer 30 is positioned between the positive electrode layer 10 and the negative electrode layer 20 and is in contact with the positive electrode layer 10 and the negative electrode layer 20.

The first solid electrolyte layer 30 is conductive to metal ions such as lithium ions, sodium ions, magnesium ions, potassium ions, calcium ions, or copper ions. The first solid electrolyte layer 30 may be conductive to lithium ions.

The first solid electrolyte layer 30 contains at least a solid electrolyte and may contain a binder material as necessary. The first solid electrolyte layer 30 may also contain a solid electrolyte conductive to lithium ions.

As the solid electrolyte of the first solid electrolyte layer 30, the solid electrolyte material described above can be used. For the first solid electrolyte layer 30, one type of solid electrolyte may be used, or two or more types of solid electrolytes may be used. As the binder material for the first solid electrolyte layer 30, the binder material described above can be used.

The first solid electrolyte layer 30 has a thickness of, for example, greater than or equal to 0.1 μm and less than or equal to 1000 μm. From the viewpoint of improving the energy density of the battery 500, the first solid electrolyte layer 30 may have a thickness of greater than or equal to 0.1 μm and less than or equal to 50 μm.

Examples of a method of forming the first solid electrolyte layer 30 include a method wherein a powdered material containing the first solid electrolyte layer 30 is subjected to uniaxial compression molding, and the like. The first solid electrolyte layer 30 may be formed by applying and drying a paste-like paint, in which the material containing the first solid electrolyte layer 30 is kneaded together with a solvent, on a substrate, the positive electrode layer 10, the negative electrode layer 20 or the like.

A side surface of the positive electrode layer 10, a side surface of the negative electrode layer 20, and a side surface of the first solid electrolyte layer 30 are flush with each other, and constitute a side surface of the power generating element 50. The side surfaces of the positive electrode layer 10, the negative electrode layer 20, and the first solid electrolyte layer 30 do not have to be flush with each other. For example, the first solid electrolyte layer 30 may cover the side surfaces of the positive electrode layer 10 and the negative electrode layer 20, and the side surface of the power generating element 50 may be configured only by the side surface of the first solid electrolyte layer 30.

The positive electrode current collector 60 is disposed on the side of the positive electrode layer 10 opposite to the first solid electrolyte layer 30 and is in contact with the positive electrode layer 10. The negative electrode current collector 70 is disposed on the side of the negative electrode layer 20 opposite to the first solid electrolyte layer 30 and is in contact with the negative electrode layer 20.

Examples of materials for the positive electrode current collector 60 and the negative electrode current collector 70 include a highly conductive metal material such as copper, aluminum, nickel, iron, stainless steel, platinum, gold, alloys of two or more of these metals or a material obtained by plating of any of these metals. The positive electrode current collector 60 and the negative electrode current collector 70 may be made of the same material, or may be made of different materials.

The shape of the positive electrode current collector 60 and the negative electrode current collector 70 may be set according to the shape of the battery 500 and the like, and thus are not particularly limited. The shape of the positive electrode current collector 60 and the negative electrode current collector 70 is, for example, rod-like, plate-like, sheet-like, foil-like, mesh-like, or the like.

The positive electrode current collector 60 and the negative electrode current collector 70 each have a thickness of, for example, greater than or equal to 1 μm and less than or equal to 10 mm. The thickness of the positive electrode current collector 60 and the negative electrode current collector 70 may be greater than or equal to 1 μm and less than or equal to 50 μm. Alternatively, depending on the shape of the battery 500, the thickness of the positive electrode current collector 60 and the negative electrode current collector 70 may be greater than or equal to 10 mm.

The plan-view shape of each of the positive electrode layer 10, the negative electrode layer 20, the first solid electrolyte layer 30, the positive electrode current collector 60, and the negative electrode current collector 70 is, for example, rectangular, circular, polygonal or the like. For example, the positive electrode layer 10, the negative electrode layer 20, the first solid electrolyte layer 30, the positive electrode current collector 60, and the negative electrode current collector 70 have their outer edges aligned with each other as seen from the laminating direction. Note that the positive electrode layer 10, the negative electrode layer 20, the first solid electrolyte layer 30, the positive electrode current collector 60, and the negative electrode current collector 70 do not have to have their outer edges aligned with each other as seen from the laminating direction.

The structure 200 is provided so as to cover the side surface 100a of the solid-state battery section 100. When the solid-state battery section 100 has a rectangular parallelepiped shape, the structure 200 covers only one side surface 100a of the four side surfaces of the solid-state battery section 100, for example. Although one structure 200 is provided on the side surface 100a, a plurality of structures 200 each having the reference electrode section 170 and the insulating member 190 may be provided on the side surface 100a. Alternatively, the plurality of structures 200 may be provided on two or more of the four side surfaces of the solid-state battery section 100.

In plan view of the side surface 100a of the solid-state battery section 100, the structure 200 does not protrude beyond both ends of the solid-state battery section 100 in the laminating direction of the solid-state battery section 100. In this embodiment, in plan view of the side surface 100a, the outermost periphery of the structure 200 is formed of the insulating member 190, and the insulating member 190 does not protrude beyond the both ends of the solid-state battery section 100 in the laminating direction of the solid-state battery section 100. The length of the structure 200 in the laminating direction of the solid-state battery section 100 is less than or equal to the length of the solid-state battery section 100 in the laminating direction of the solid-state battery section 100. Thus, even when the solid-state battery section 100 is pressurized in the laminating direction in order to maintain the battery characteristics, the structure 200 is less likely to interfere with the pressurization of the solid-state battery section 100, and the pressurized state of the solid-state battery section 100 is easily maintained. Since deformation of the structure 200 due to the pressurization of the solid-state battery section 100 is suppressed, the reliability of the battery 500 can be improved. In this embodiment, the length of the structure 200 in the laminating direction of the solid-state battery section 100 is the same as the length of the solid-state battery section 100 in the laminating direction of the solid-state battery section 100.

The shape of the structure 200 is, for example, a rectangular parallelepiped shape, but may be a cylindrical shape, a polygonal prism shape or the like, or may be a shape curved in accordance with the shape of the solid-state battery section 100. Moreover, a convex portion or a concave portion may be formed in part of the surface of the structure 200.

The structure 200 includes: at least one reference electrode section 170 including the second solid electrolyte layer 130, a reference electrode 110, and the reference electrode current collector 150; and the insulating member 190. The second solid electrolyte layer 130, the reference electrode 110, and the reference electrode current collector 150 are arranged in this order along the normal direction of the side surface 100a so as to be separated from the side surface 100a. In this embodiment, the structure 200 includes a plurality of reference electrode sections 170. The number of the reference electrode sections 170 is not particularly limited, but is the same as the number of the power generating elements 50, for example. For example, one reference electrode section 170 is provided for one power generating element 50. For example, in order to measure the electrical characteristics of the positive electrode layer 10 and the negative electrode layer 20 in the power generating element 50, at least one reference electrode section 170 is provided for each of all the plurality of power generating elements 50. Note that the plurality of power generating elements 50 may include power generating elements 50 for which no reference electrode section 170 is provided.

In this embodiment, the plurality of reference electrode sections 170 each include the second solid electrolyte layer 130, the reference electrode 110, and the reference electrode current collector 150.

The second solid electrolyte layer 130 is positioned between the reference electrode 110 and the solid-state battery section 100.

The second solid electrolyte layer 130 has a first principal surface 130a and a second principal surface 130b opposite to the first principal surface 130a. The first and second principal surfaces 130a and 130b are principal surfaces facing back-to-back with each other. The side surface 100a and the first and second principal surfaces 130a and 130b are parallel to each other, for example.

The second solid electrolyte layer 130 is in contact with the power generating elements 50 on the side surface 100a of the solid-state battery section 100 so as not to come into contact with two or more power generating elements 50 among the plurality of power generating elements 50. Therefore, the second solid electrolyte layer 130 is in contact with only one power generating element 50 among the plurality of power generating elements 50 on the side surface 100a. To be more specific, the first principal surface 130a of the second solid electrolyte layer 130 is in contact with the side surface of one power generating element 50. The first principal surface 130a is in contact with at least part of the side surface of each of the positive electrode layer 10, the negative electrode layer 20, and the first solid electrolyte layer 30 included in the one power generating element 50 on the structure 200 side. The first principal surface 130a may be in contact with at least one side surface of the positive electrode layer 10, the negative electrode layer 20, and the first solid electrolyte layer 30 included in the one power generating element 50.

The first principal surface 130a may also be in contact with at least one of the positive electrode current collector 60 and the negative electrode current collector 70, which are in contact with the one power generating element 50. The longer the length of the first principal surface 130a in the laminating direction of the solid-state battery section 100, the higher the mechanical strength. The length of the first principal surface 130a in the laminating direction of the solid-state battery section 100 is, for example, greater than or equal to the length of the side surface of the power generating element 50 in the laminating direction of the solid-state battery section 100. When the first principal surface 130a is not in contact with the power generating element 50 located next to the one power generating element 50, the first principal surface 130a may be in contact with the positive electrode current collector 60 and the negative electrode current collector 70 disposed between these two adjacent power generating elements 50.

In plan view of the side surface 100a, the width of the second solid electrolyte layer 130 is smaller than the width of the power generating element 50, and the second solid electrolyte layer 130 is positioned inside both ends of the power generating element 50 in the width direction. Here, the “width” is the length in a direction orthogonal to the laminating direction in plan view of the side surface 100a. Note that both ends of the second solid electrolyte layer 130 in the width direction may coincide with the both ends of the power generating element 50 in the width direction in plan view of the side surface 100a.

A plurality of second solid electrolyte layers 130, which are the second solid electrolyte layers 130 included in the plurality of reference electrode sections 170, respectively, are in contact with different power generating elements 50 among the plurality of power generating elements 50, respectively. Each of the plurality of second solid electrolyte layers 130 is in contact with one of the plurality of power generating elements 50, for example. The number of the plurality of second solid electrolyte layers 130 is the same as the number of the plurality of power generating elements 50, for example. Note that there may be power generating elements 50 that are not in contact with the second solid electrolyte layer 130.

Here, the arrangement of the plurality of second solid electrolyte layers 130 in plan view of the side surface 100a will be described with reference to FIG. 2B. Since the reference electrode 110 and the reference electrode current collector 150 are arranged on the second solid electrolyte layer 130, the arrangement of the plurality of second solid electrolyte layers 130 is also the arrangement of the plurality of reference electrode sections 170.

The plurality of second solid electrolyte layers 130 are provided inside a plurality of openings 190a provided in the insulating member 190, respectively. Each of the plurality of openings 190a exposes at least some of the power generating elements 50 so as not to expose two or more power generating elements 50 out of the plurality of power generating elements 50 on the side surface 100a of the solid-state battery section 100. The second solid electrolyte layer 130 is in contact with a part of the region of the side surface 100a exposed by the opening 190a. The second solid electrolyte layer 130 may be in contact with the entire region of the side surface 100a exposed by the opening 190a.

The reference electrode 110 may also be provided inside the opening 190a, and the reference electrode current collector 150 may be further provided. In the example shown in FIG. 2B, a sidewall of the opening 190a is partially open, but the opening 190a may be entirely surrounded by the sidewall. Also, the opening 190a may have a slit shape sandwiched between side walls.

The insulating member 190 is disposed between the plurality of second solid electrolyte layers 130. The plurality of second solid electrolyte layers 130 also include two second solid electrolyte layers 130 in contact with each of the adjacent power generating elements 50 among the plurality of power generating elements 50. The two second solid electrolyte layers 130 do not overlap as seen from the laminating direction of the solid-state battery section 100. Accordingly, the distance between the two second solid electrolyte layers 130 can be increased, and thus contact between the two second solid electrolyte layers 130 can be suppressed. Therefore, the reliability of the battery 500 can be further improved.

In the example shown in FIG. 2B, the number of the plurality of second solid electrolyte layers 130 is greater than or equal to four, specifically five. The plurality of second solid electrolyte layers 130 are arranged on the side surface 100a so as to form a plurality of rows L11 and L12 extending along a direction not orthogonal to the laminating direction of the solid-state battery section 100. The plurality of rows L11 and L12 extend along the laminating direction. Thus, the plurality of second solid electrolyte layers 130 are dispersed into the plurality of rows L11 and L12 and arranged in a certain pattern. Therefore, the plurality of second solid electrolyte layers 130 can be arranged compactly while increasing the mechanical strength of the structure 200. In the plurality of rows L11 and L12, the plurality of second solid electrolyte layers 130 are arranged at regular intervals, for example. The number of the rows L11 and L12 is two in the example shown in FIG. 2B, but may be greater than or equal to three depending on the number of the second solid electrolyte layers 130.

The arrangement of the plurality of second solid electrolyte layers 130 (that is, the arrangement of the plurality of reference electrode sections 170) is not particularly limited as long as the second solid electrolyte layers 130 in the reference electrode sections 170 do not come into contact with each other. For example, the plurality of second solid electrolyte layers 130 may be arranged in a row or randomly arranged. Alternatively, the plurality of second solid electrolyte layers 130 may be arranged in a stripe pattern.

As a material of the second solid electrolyte layer 130, the same material as that of the first solid electrolyte layer 30 may be used. The same material or different materials may be used for the first and second solid electrolyte layers 30 and 130. One type of solid electrolyte or two or more types of solid electrolytes may be used for the second solid electrolyte layer 130.

The second solid electrolyte layer 130 has a thickness of, for example, greater than or equal to 10 μm and less than or equal to 10 mm. The thickness of the second solid electrolyte layer 130 is, for example, greater than the thickness of the first solid electrolyte layer 30. In the present specification, the thickness of each constituent element of the structure 200 is the length of each constituent element in the normal direction of the side surface 100a of the solid-state battery section 100.

The reference electrode 110 faces the side surface 100a across the second solid electrolyte layer 130, and is in contact with the second solid electrolyte layer 130. To be more specific, the reference electrode 110 is in contact with the second principal surface 130b of the second solid electrolyte layer 130. Accordingly, the reference electrode 110 is connected in an ion conductive manner to the positive electrode layer 10 and the negative electrode layer 20 through the second solid electrolyte layer 130. Thus, the electrical characteristics of the positive electrode layer 10 and the negative electrode layer 20 can be measured by using the reference electrode 110. The reference electrode 110 is surrounded by the insulating member 190 in plan view of the side surface 100a of the solid-state battery section 100.

As shown in FIG. 2B, the area of the reference electrode 110 is smaller than that of the second principal surface 130b in plan view of the second principal surface 130b. The area of the reference electrode 110 in plan view of the second principal surface 130b is the area of the region surrounded by the outer edge of the reference electrode 110 in plan view of the second principal surface 130b. In plan view of the second principal surface 130b, the reference electrode 110 is located inside the outer edge of the second principal surface 130b. That is, in plan view of the second principal surface 130b, the entire reference electrode 110 is provided on a region of the second principal surface 130b and positioned inside the second principal surface 130b. As a result, the reference electrode 110 and the solid-state battery section 100 are less likely to come into contact with each other, thus suppressing short-circuiting between the reference electrode 110 and the solid-state battery section 100. Note that the reference electrode 110 may be in contact with the entire second principal surface 130b.

As a material of the reference electrode 110, any material can be used without particular limitation as long as the material exhibits an equilibrium potential when in electrochemical contact with the second solid electrolyte layer 130. The reference electrode 110 includes at least one of metallic lithium, a lithium alloy, and a lithium compound, for example. From the viewpoint of measurement accuracy, a material with a small equilibrium potential variation may be used as the material of the reference electrode 110. Examples of the material with a small equilibrium potential variation include metallic lithium, lithium alloys such as In—Li, and lithium compounds such as Li₄T₁₅O₁₂.

The reference electrode current collector 150 is positioned on the side of the reference electrode 110 opposite to the second solid electrolyte layer 130 and is in contact with the reference electrode 110. For example, the reference electrode current collector 150 covers the entire surface of the reference electrode 110 opposite to the second solid electrolyte layer 130. The position where the reference electrode current collector 150 comes into contact with the reference electrode 110 is not particularly limited, and the reference electrode current collector 150 may be in contact with any surface other than the surface where the reference electrode 110 comes into contact with the second solid electrolyte layer 130.

The surface of the reference electrode current collector 150 opposite to the reference electrode 110 side is exposed to the outside, and is connected to a terminal or the like for measuring electrical characteristics, for example. Note that the reference electrode section 170 does not have to include the reference electrode current collector 150, and the electrical characteristics may be measured, for example, by bringing the terminal or the like into direct contact with the reference electrode 110.

In plan view of the side surface 100a, the outer edge of the reference electrode current collector 150 coincides with the outer edge of the second solid electrolyte layer 130, for example. In other words, the reference electrode current collector 150 and the second solid electrolyte layer 130 have the same size in plan view of the side surface 100a. The reference electrode current collector 150 is larger than the reference electrode 110. The reference electrode current collector 150 includes the reference electrode 110 in plan view of the side surface 100a. Note that the reference electrode current collector 150 and the second solid electrolyte layer 130 may have different sizes in plan view of the side surface 100a. The outer edge of the reference electrode current collector 150 may coincide with the outer edge of the reference electrode 110 or may be positioned inside the outer edge of the reference electrode 110 in plan view of the side surface 100a.

Examples of materials for the reference electrode current collector 150 include a highly conductive metal material such as copper, aluminum, nickel, iron, stainless steel, platinum, gold, alloys of two or more of these metals or a material obtained by plating of any of these metals.

The shape of the reference electrode current collector 150 may be set according to the shape of the structure 200 and the like, and thus is not particularly limited. The shape of the reference electrode current collector 150 is, for example, rod-like, plate-like, sheet-like, foil-like, mesh-like, or the like.

The reference electrode current collector 150 has a thickness of, for example, greater than or equal to 1 μm and less than or equal to 20 mm. Depending on the shapes of the battery 500 and the structure 200, the thickness of the reference electrode current collector 150 may be greater than or equal to 10 mm.

In plan view of the side surface 100a, the shape of each of the second solid electrolyte layer 130, the reference electrode 110, and the reference electrode current collector 150 is, for example, rectangular, circular, polygonal or the like. In plan view of the side surface 100a, the reference electrode 110 and the reference electrode current collector 150 do not protrude beyond the outer edge of the second solid electrolyte layer 130, for example.

The insulating member 190 is arranged so as to surround each of the plurality of second solid electrolyte layers 130 in plan view of the side surface 100a of the solid-state battery section 100. The insulating member 190 may be arranged so as to surround the second solid electrolyte layer 130 at least from both sides in a predetermined direction in plan view of the side surface 100a of the solid-state battery section 100. For example, the insulating member 190 surrounds the second solid electrolyte layer 130 so as to sandwich the second solid electrolyte layer 130 at least from both sides in the laminating direction of the solid-state battery section 100. When the plan-view shape of the second solid electrolyte layer 130 is rectangular, the insulating member 190 surrounds the second solid electrolyte layer 130 so as to cover only two opposing sides and another side of the second solid electrolyte layer 130 as shown in FIG. 2B, for example. When the plan-view shape of the second solid electrolyte layer 130 is rectangular, the insulating member 190 may surround the second solid electrolyte layer 130 so as to cover only the two opposing sides of the second solid electrolyte layer 130 or to cover all four sides.

The insulating member 190 is an insulating member layer whose thickness direction is the normal direction of the side surface 100a, for example. In plan view of the side surface 100a, the insulating member 190 is continuous, which is arranged so as to surround each of the plurality of second solid electrolyte layers 130. The insulating member 190 is integrally formed so as to surround each of the plurality of second solid electrolyte layers 130, for example. Thus, the mechanical strength of the structure 200 can be further enhanced. Note that the insulating member 190 may be divided into a plurality of parts.

The insulating member 190 covers the side surface of the second solid electrolyte layer 130, which is a surface that connects the outer edges of the first and second principal surfaces 130a and 130b, for example. The insulating member 190 is in contact with the side surface of the second solid electrolyte layer 130. The side surface of each constituent element of the structure 200 is, for example, a surface parallel to the normal direction of the side surface 100a of the solid-state battery section 100. In the illustrated example, the insulating member 190 is in contact with three of the four side surfaces of the second solid electrolyte layer 130. The insulating member 190 is in contact with, for example, at least one of the four side surfaces of the second solid electrolyte layer 130.

The insulating member 190 covers the side surface 100a of the solid-state battery section 100 and is in contact with the side surface 100a. The insulating member 190 covers a region of the side surface 100a that is not in contact with the second solid electrolyte layer 130. For example, the insulating member 190 continuously covers from one end to the other end of the side surface 100a in the laminating direction. The insulating member 190 may not cover at least one of one end and the other end of the side surface 100a in the laminating direction.

In plan view of the side surface 100a of the solid-state battery section 100, the insulating member 190 is arranged so as to surround the reference electrode 110 and the reference electrode current collector 150. Accordingly, the reference electrode 110 and the reference electrode current collector 150 are also protected by the insulating member 190, and thus the mechanical strength of the structure 200 can be further enhanced. Therefore, the reliability of the battery 500 can be further improved.

The insulating member 190 is not in contact with the reference electrode 110 and a gap is provided between the insulating member 190 and the reference electrode 110. The insulating member 190 is in contact with the reference electrode current collector 150. Note that the insulating member 190 may be in contact with the side surface of the reference electrode 110 so as to fill the gap.

The thickness of the insulating member 190 is, for example, greater than the sum of the thicknesses of the second solid electrolyte layer 130 and the reference electrode 110. Note that the thickness of the insulating member 190 may be less than or equal to the sum of the thicknesses of the second solid electrolyte layer 130 and the reference electrode 110. The thickness of the insulating member 190 may be, for example, greater than or equal to the thickness of the second solid electrolyte layer 130 and less than or equal to the sum of the thicknesses of the second solid electrolyte layer 130 and the reference electrode 110.

The insulating member 190 is formed of an insulating material including insulating resin, ceramics or the like. The insulating material used for the insulating member 190 consists mainly of, for example, insulating resin. The insulating material may further contain various additives and the like for resin. Examples of the insulating resins include epoxy resin, silicone resin, polycarbonate resin, polybutadiene resin, acrylic resin, polyamide resin, polyacetal resin, and the like. The insulating resin may be thermoplastic resin, thermosetting resin or photocurable resin. One kind of insulating resin may be used or two or more kinds of insulating resins may be used for the insulating member 190. Although the side surface 100a of the solid-state battery section 100 has fine unevenness derived from the material of each layer of the power generating element 50, the insulating resin contained in the insulating member 190 causes a bonding anchor effect between such unevenness and the insulating resin of the insulating member 190, making it possible to improve bondability between the solid-state battery section 100 and the structure 200. Therefore, the mechanical strength of the battery 500 is enhanced, and the second solid electrolyte layer 130 is strongly protected by the insulating member 190. Thus, the reliability of the battery 500 can be improved.

### Method for Manufacturing Battery

Next, a method for manufacturing the battery 500 according to this embodiment will be described. Note that the method for manufacturing the battery 500 is not limited to the following example.

Examples of the method for manufacturing the battery 500 include a method wherein a solid-state battery section 100 is fabricated first and then a structure 200 is formed on a side surface 100a of the solid-state battery section 100 thus fabricated.

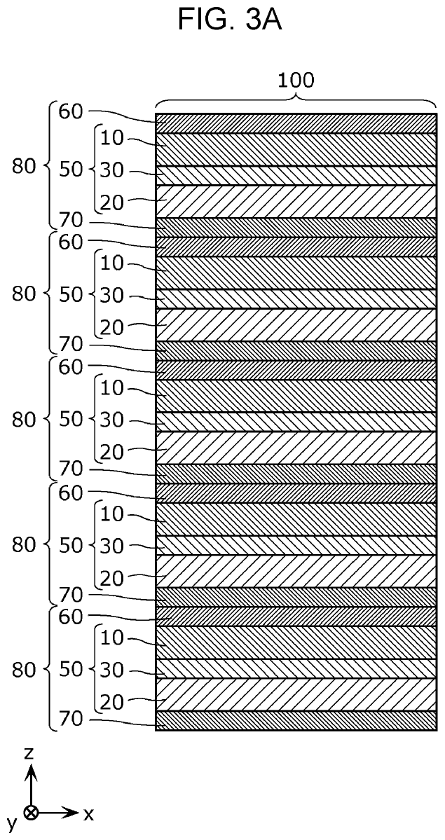

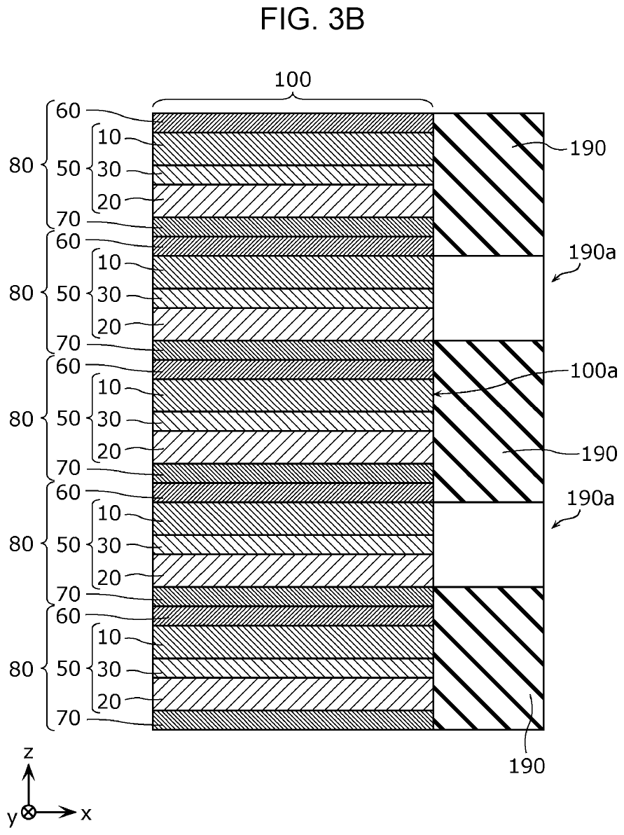

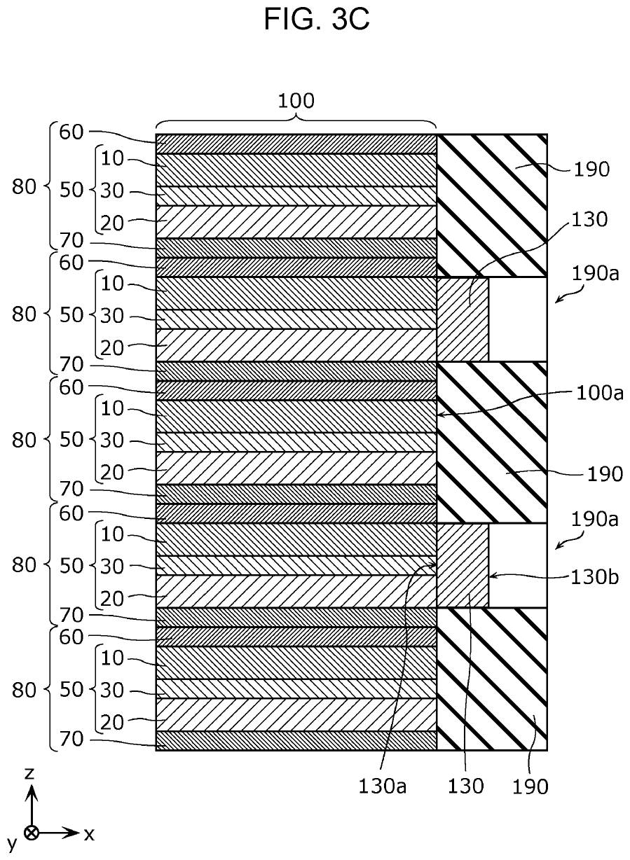

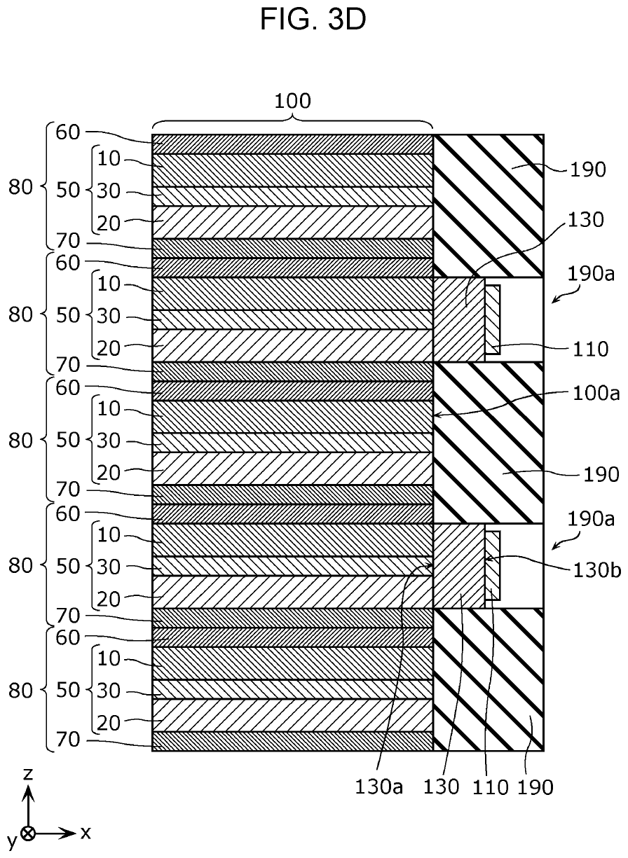

FIGS. 3A to 3D are cross-sectional views for explaining the method for manufacturing the battery 500. As shown in FIG. 3A, a solid-state battery section 100 is fabricated first. As a method for fabricating the solid-state battery section 100, a method similar to a general method for manufacturing a battery can be used. For example, first, powders of a material to form a positive electrode layer 10, a material to form a first solid electrolyte layer 30, and a material to form a negative electrode layer 20 are sequentially pressurized and compression-molded to form a power generating element 50. Next, a positive electrode current collector 60 is laminated so as to come into contact with the positive electrode layer 10 in the power generating element 50, and a negative electrode current collector 70 is laminated so as to come into contact with the negative electrode layer 20 in the power generating element 50. Thus, a plurality of unit battery cells 80 are fabricated, each of which is the power generating element 50 having the current collectors laminated therein. By laminating the unit battery cells 80 so as to be electrically connected in series, the solid-state battery section 100 is fabricated.

Next, as shown in FIG. 3B, an insulating member 190 is formed on a side surface 100a of the solid-state battery section 100 thus fabricated. The insulating member 190 is formed, for example, by applying insulating resin to the side surface 100a in a pattern in which openings 190a are formed at desired locations. By thus applying the insulating resin to the side surface 100a, a bonding anchor effect can be achieved, in which the insulating resin enters the unevenness on the side surface 100a.

Then, as shown in FIG. 3C, a second solid electrolyte layer 130 is formed inside the openings 190a. The second solid electrolyte layer 130 is formed, for example, by applying a material to form the second solid electrolyte layer 130 onto a region of the side surface 100a exposed by the openings 190a. Note that the second solid electrolyte layer 130 may be formed before the insulating member 190 is formed. In this case, after forming the second solid electrolyte layer 130, the insulating member 190 is formed so as to surround the second solid electrolyte layer 130 formed on the side surface 100a in plan view of the side surface 100a.

Thereafter, as shown in FIG. 3D, a reference electrode 110 is formed by disposing or applying a material to form the reference electrode 110 on the second solid electrolyte layer 130 formed inside the opening 190a. Then, by disposing a reference electrode current collector 150 so as to come into contact with the reference electrode 110 thus formed, a battery 500 can be manufactured.

Another method for manufacturing the battery 500 is a method wherein a solid-state battery section 100 and a structure 200 are separately fabricated and the structure 200 is pressed against a side surface 100a of the solid-state battery section 100. To be more specific, an insulating member 190 having openings 190a is prepared, a second solid electrolyte layer 130 is formed inside the openings 190a, and then a reference electrode 110 and a reference electrode current collector 150 are further formed, thus fabricating the structure 200. Then, the fabricated structure 200 is pressed against the side surface 100a of the solid-state battery section 100 fabricated by the above method or the like. In this event, the structure 200 is pressed in a state where each reference electrode section 170 is aligned with a side surface of a power generating element 50 to be measured. Thus, the battery 500 can be manufactured, and electrochemical contact is formed between the second solid electrolyte layer 130 and the power generating element 50.

### Method for Measuring Electrical Characteristics of Battery

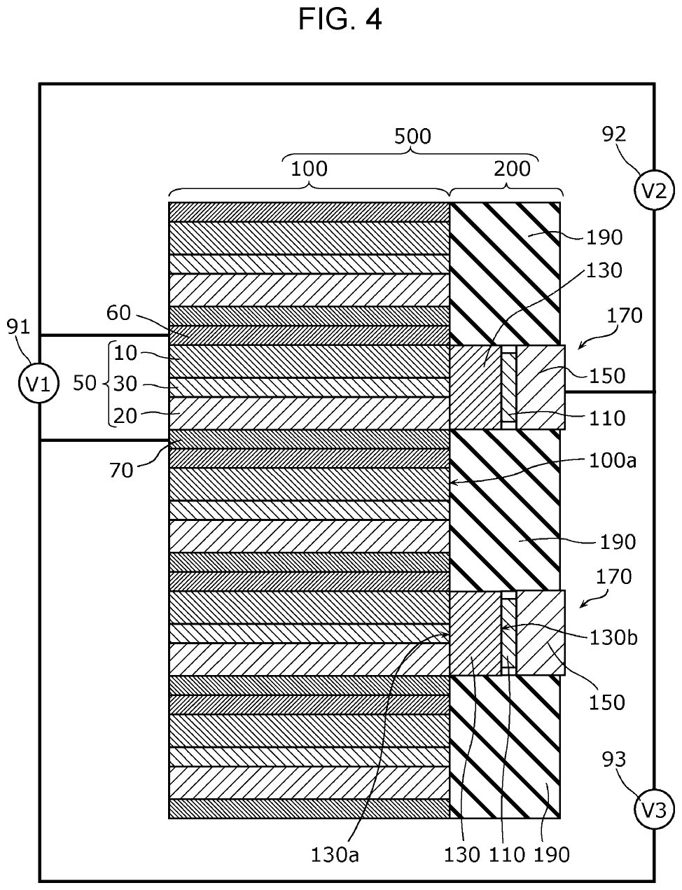

Next, a method for measuring electrical characteristics of the battery 500 according to this embodiment will be described. To be more specific, a method for measuring electrical characteristics of the battery 500 including the power generating element 50 will be described with reference to FIG. 4.

FIG. 4 is a diagram for explaining the method for measuring the electrical characteristics of the battery 500.

As shown in FIG. 4, in the battery 500, a voltage measuring device 91 is electrically connected to the positive electrode layer 10 and the negative electrode layer 20 in one of the power generating elements 50 having the reference electrode section 170 formed on its side surface, through the positive electrode current collector 60 and the negative electrode current collector 70. A voltage measuring device 92 is electrically connected to the positive electrode layer 10 and the reference electrode 110 through the positive electrode current collector 60 and the reference electrode current collector 150. A voltage measuring device 93 is electrically connected to the negative electrode layer 20 and the reference electrode 110 through the negative electrode current collector 70 and the reference electrode current collector 150. Thus, a voltage V1 between the positive electrode layer 10 and the negative electrode layer 20, a voltage V2 between the positive electrode layer 10 and the reference electrode 110, and a voltage V3 between the negative electrode layer 20 and the reference electrode 110 can be measured. Accordingly, electrical characteristics are measured, such as the voltage between at least one of the positive electrode layer 10 and the negative electrode layer 20 and the reference electrode 110. Also, as the electrical characteristic, electrical characteristics other than the voltage, such as impedance, may be measured.

In this event, regardless of operations of the positive electrode layer 10 and the negative electrode layer 20, the reference electrode 110 exhibits a constant value as an equilibrium potential with the second solid electrolyte layer 130. Thus, the potential of the positive electrode layer 10 and/or the negative electrode layer 20 can be measured as a voltage difference between the reference electrode 110 and the positive electrode layer 10 and/or the negative electrode layer 20.

Although the measurement in one of the power generating elements 50 has been described here as an example, the measurement can also be simultaneously performed by the same method for the power generating elements 50 each having the reference electrode section 170 formed thereon.

### Effects or the Like

As for a solid-state battery having a reference electrode of the related art, various structures have been studied as disclosed in “Q & A de Rikaisuru Denkikagaku no Sokutei Hou (Understanding of Electrochemical Measurement Method with Q & A)” edited by The Electrochemical Society of Japan, published by Mimizuku-sha in December 2009, p. 10. However, the structure thereof is complicated, and it is difficult to apply the structure to a practical battery.

The solid-state battery having a reference electrode disclosed in Japanese Unexamined Patent Application Publication No. 2013-20915 has a structure in which a positive electrode, a solid electrolyte layer, and a negative electrode are laminated and a third electrode is provided as a reference electrode that is in contact with a solid electrolyte section provided so as to connect with a width that matches the length of the side surface of the solid electrolyte layer or the positive electrode, the solid electrolyte layer, and the negative electrode. In this solid-state battery, the potential of the positive electrode and/or the negative electrode can be measured.

However, when the solid electrolyte section protrudes from the solid-state battery section as in the structure disclosed in Japanese Unexamined Patent Application Publication No. 2013-20915, the solid electrolyte section is mechanically weak, making it difficult to maintain the shape of the solid electrolyte section and to perform stable potential measurement.

In this embodiment, in order to perform three-electrode measurement, the second solid electrolyte layer 130 in contact with the power generating element 50 is in electrochemical contact with the power generating element 50 so as not to come into contact with two or more power generating elements 50. Also, the insulating member 190 is disposed so as to surround the second solid electrolyte layer 130 in the reference electrode section 170 formed for one power generating element 50. Therefore, as shown in FIG. 1, for example, the battery 500 includes: the solid-state battery section 100 in which a plurality of power generating elements 50 are electrically connected in series and laminated; and the structure 200 having the reference electrode section 170 and the insulating member 190 arranged so as to sandwich the reference electrode section 170 from both sides in the laminating direction. Moreover, the insulating member 190 covers the side surface 100a and is in contact with the side surface 100a.

With such a configuration, the insulating member 190 can enhance the mechanical strength of the reference electrode section 170. By covering the side surface 100a with the insulating member 190 while surrounding the second solid electrolyte layer 130, electrical and ion conductive short-circuiting can be suppressed between the reference electrode section 170 and the solid-state battery section 100 and between the plurality of power generating elements 50 in the solid-state battery section 100. Therefore, the reliability of the battery 500 can be improved. In addition, even when stored in a thin outer package such as a laminate film, the shape of the reference electrode section 170 is maintained by the insulating member 190, and stable potential measurement can also be performed in the battery 500 having the plurality of power generating elements 50 laminated therein.

In plan view of the second principal surface 130b, the area of the reference electrode 110 is smaller than the area of the second principal surface 130b, and the entire reference electrode 110 is positioned inside the second principal surface 130b. This makes it difficult for the reference electrode 110 and the solid-state battery section 100 to come into contact with each other. For example, even when pressure is applied to improve the contact between the side surface 100a of the solid-state battery section 100 and the second solid electrolyte layer 130, short-circuiting can be prevented between the reference electrode 110 and the solid-state battery section 100.

Further, a plurality of reference electrode sections 170 formed on the side surface 100a of the solid-state battery section 100 are geometrically arranged in a predetermined pattern, and the insulating member 190 is disposed between the plurality of second solid electrolyte layers 130. Accordingly, the plurality of reference electrode sections 170 are appropriately dispersed and arranged. Thus, a large number of reference electrode sections 170 can be formed in a compact area while increasing the mechanical strength of the plurality of reference electrode sections 170.

With the above configuration, the battery 500 can be realized, which is capable of maintaining stable measurement of electrical characteristics such as the potentials of the positive electrode layer 10 and the negative electrode layer 20 in at least one of the plurality of laminated power generating elements 50. Therefore, according to this embodiment, the electrical characteristics of the electrodes can be measured, and a highly reliable battery 500 can be realized.

Since the potential of the positive electrode layer 10 and/or the negative electrode layer 20 alone can be measured using the battery 500 according to this embodiment, the electrical characteristics of the positive electrode layer 10 and/or the negative electrode layer 20 in the laminated battery can be determined in the development of batteries. At the same time, the electrical characteristics can be measured separately from the positive electrode layer 10 and the negative electrode layer 20. Therefore, the development and design of batteries can be effectively and efficiently promoted.

When the battery 500 according to this embodiment applied to and developed as a practical battery, the following effects can be realized, for example. In the positive electrode layer 10, when the structure of the active material changes at a certain potential or higher, for example, and the electrode performance such as charge/discharge capacity and cycle characteristics deteriorates, the potential of the positive electrode layer 10 can be monitored and controlled so as not to exceed the certain potential. As a result, in the battery 500, deterioration in electrode performance due to charging can be suppressed. As for the negative electrode layer 20, in the case of an electrode that is used up to near a deposition potential of metallic lithium during charging, for example, metallic lithium deposition can be suppressed by monitoring and controlling the potential so as not to reach the deposition potential of metallic lithium (for example, lower than or equal to 0 V, vs. Li+/Li). As a result, in the battery 500, it is possible to prevent shortening of the battery life due to a decrease in charge/discharge capacity and cycle deterioration, and to reduce the risk of short-circuit phenomenon, heating, and ignition due to deposition of metallic lithium.

### Modified Example 1

Next, modified example 1 of the embodiment will be described. In the following description of the modified example, differences from the embodiment will be mainly described, and description of similarities will be omitted or simplified.

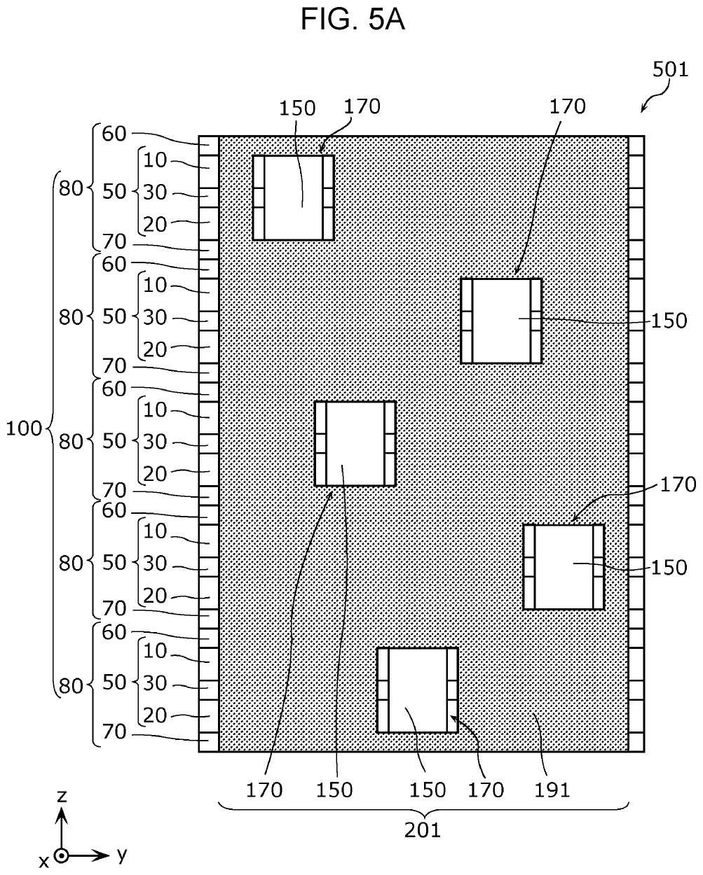

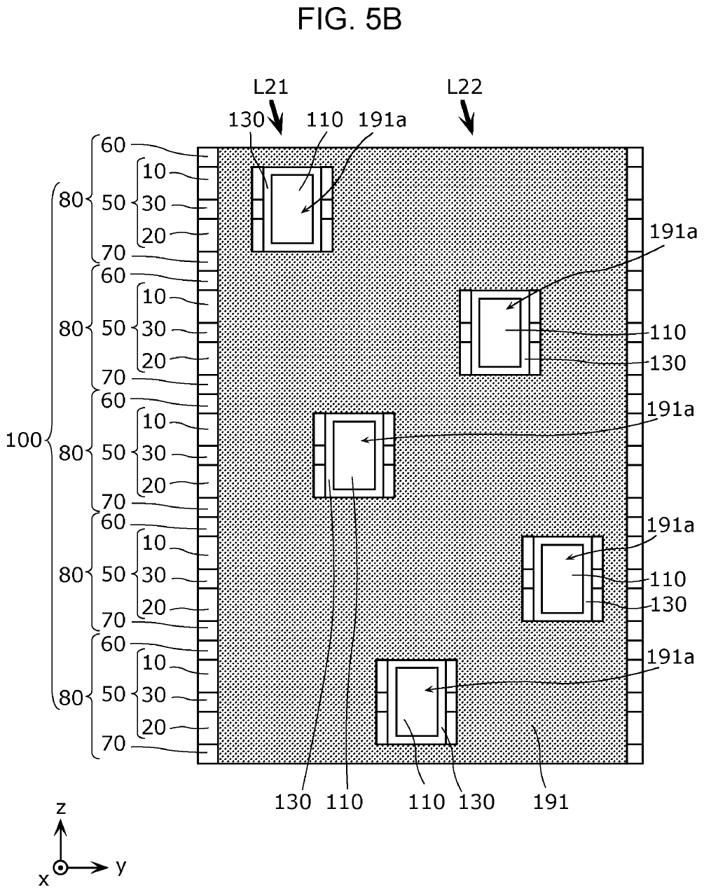

FIG. 5A is a side view showing a schematic configuration of a battery 501 according to this modified example. FIG. 5A is a plan view of a side surface 100a of a solid-state battery section 100. FIG. 5B is a side view showing a state where a reference electrode current collector 150 is removed from the battery 501 shown in FIG. 5A. In FIGS. 5A and 5B, an insulating member 191 has a dot pattern in order to make it easier to recognize a region where the insulating member 191 is formed, but this is not intended to mean that the actual insulating member 191 has the dot pattern.

As shown in FIG. 5A, the battery 501 is different from the battery 500 according to the embodiment in including a structure 201 instead of the structure 200.

The structure 201 has the same configuration as that of the structure 200 except that the arrangement of the reference electrode section 170 is different from that of the structure 200. The structure 201 has the insulating member 191 provided with a plurality of openings 191a arranged differently from those of the insulating member 190. The insulating member 191 has the same configuration as that of the insulating member 190 except that a plan-view shape is different from that of the insulating member 190.

As shown in FIG. 5B, a plurality of second solid electrolyte layers 130 are provided inside the plurality of openings 191a provided in the insulating member 191, respectively. Each of the second solid electrolyte layers 130 is in contact with a region of the side surface 100a exposed by the opening 191a.

The insulating member 191 completely surrounds each of the second solid electrolyte layers 130 in plan view of the side surface 100a of the solid-state battery section 100. Thus, the reference electrode section 170 is protected more strongly. The insulating member 191 is also in contact with both end faces of the second solid electrolyte layer 130 in the laminating direction of the solid-state battery section 100.

The insulating member 191 is arranged between the plurality of second solid electrolyte layers 130. All of the plurality of second solid electrolyte layers 130 provided on the side surface 100a have portions that do not overlap each other when viewed from the laminating direction of the solid-state battery section 100. Therefore, the plurality of second solid electrolyte layers 130 have portions that overlap with only the insulating member 191 in the structure 201 when viewed from the laminating direction of the solid-state battery section 100, for example. Accordingly, even when a conductive member or the like is extended in the laminating direction from each reference electrode section 170 along the surface of the insulating member 191, the conductive member or the like does not collide with the other reference electrode sections 170. This makes it possible to simplify the structure of a connector for electrical connection with each reference electrode section 170. For example, by extending the conductive member or the like from each reference electrode section 170 along the laminating direction, a current can be extracted from the upper end or lower end of the battery 501. In this case, it is also possible to mount the battery 501 on a wiring board or the like and connect the conductive member or the like. Thus, electrical characteristics of each electrode layer can be easily measured.

The plurality of second solid electrolyte layers 130 are arranged on the side surface 100a so as to form a plurality of rows L21 and L22 extending along a direction not orthogonal to the laminating direction of the solid-state battery section 100. The direction in which the rows L21 and L22 extend is inclined with respect to the laminating direction. Thus, the plurality of second solid electrolyte layers 130 can be arranged such that the plurality of second solid electrolyte layers 130 have portions that do not overlap each other when viewed from the laminating direction of the solid-state battery section 100. Note that the plurality of second solid electrolyte layers 130 may be arranged along one row extending in a direction inclined with respect to the laminating direction.

With the above configuration, also in the battery 501 different from the battery 500 in the arrangement of the plurality of reference electrode sections 170, the electrical characteristics of electrode layers can be measured and the reliability of the battery can be improved.

### Modified Example 2

Next, modified example 2 of the embodiment will be described. In the following description of the modified example, differences from the embodiment will be mainly described, and description of similarities will be omitted or simplified.

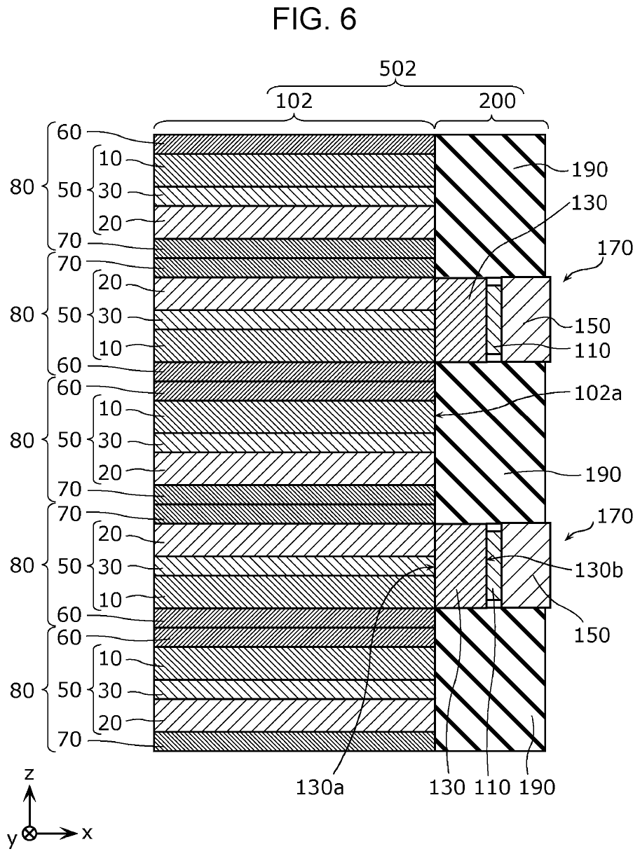

FIG. 6 is a cross-sectional view showing a schematic configuration of a battery 502 according to this modified example.

As shown in FIG. 6, the battery 502 is different from the battery 500 according to the embodiment in including a solid-state battery section 102 instead of the solid-state battery section 100.

In the solid-state battery section 102, a plurality of power generating elements 50 are electrically connected in parallel and laminated. Thus, a high-capacity battery 502 can be realized. A side surface 102a of the solid-state battery section 102 is in contact with a structure 200.

In the plurality of power generating elements 50, adjacent power generating elements 50 are laminated with positive electrode current collectors 60 or negative electrode current collectors 70 interposed therebetween. The plurality of power generating elements 50 are laminated such that layers of the same polarity in the adjacent power generating elements 50 are electrically connected to each other through the current collectors.

The plurality of power generating elements 50 are laminated such that the directions of arrangement of the layers in the adjacent power generating elements 50 are reversed. Therefore, in the adjacent power generating elements 50, the respective positive electrode layers 10 or the respective negative electrode layers 20 face each other without a first solid electrolyte layer 30 interposed therebetween. Two positive electrode current collectors 60 are arranged between the adjacent power generating elements 50 having the respective positive electrode layers 10 laminated therein so as to face each other without the first solid electrolyte layer 30 interposed therebetween. Two negative electrode current collectors 70 are arranged between the adjacent power generating elements 50 having the respective negative electrode layers 20 laminated therein so as to face each other without the first solid electrolyte layer 30 interposed therebetween. Thus, the layers of the same polarity are electrically connected to each other in the adjacent power generating elements 50. Note that the number of the positive electrode current collectors 60 and the negative electrode current collectors 70 disposed between the adjacent power generating elements 50 is not limited to two and may be one. That is, the positive electrode layers 10 may be laminated on both principal surfaces of one positive electrode current collector 60, and the negative electrode layers 20 may be laminated on both principal surfaces of one negative electrode current collector 70.

The positive electrode current collector 60, the negative electrode current collector 70, and the power generating element 50 positioned between the positive electrode current collector 60 and the negative electrode current collector 70 form a unit battery cell 80. Therefore, the solid-state battery section 102 has a structure in which a plurality of unit battery cells 80 are laminated such that electrodes of the same polarity in adjacent unit battery cells 80 are connected to each other. Thus, the plurality of unit battery cells 80 are electrically connected in parallel and laminated.

Thus, in the battery 502, the structure 200 having a plurality of reference electrode sections 170 is provided so as to come into contact with the side surface 102a of the solid-state battery section 102 having the plurality of power generating elements 50 electrically connected in parallel and laminated. Accordingly, also when the plurality of power generating elements 50 are connected in parallel, electrical characteristics of each electrode layer can be measured as in the case of the battery 500 according to the embodiment. Thus, a highly reliable battery 502 can be realized. In addition, when the plurality of power generating elements 50 are connected in parallel and laminated, ion conductive short-circuiting does not occur even when the second solid electrolyte layer 130 is in contact with two or more power generating elements 50. However, since the second solid electrolyte layer 130 is not in contact with two or more power generating elements 50, ion conduction is stabilized in measuring the electrical characteristics of each power generating element 50. Thus, the electrical characteristics can be measured with high accuracy.

### Modified Example 3

Next, modified example 3 of the embodiment will be described. In the following description of the modified example, differences from the embodiment and modified example 2 of the embodiment will be mainly described, and description of similarities will be omitted or simplified.

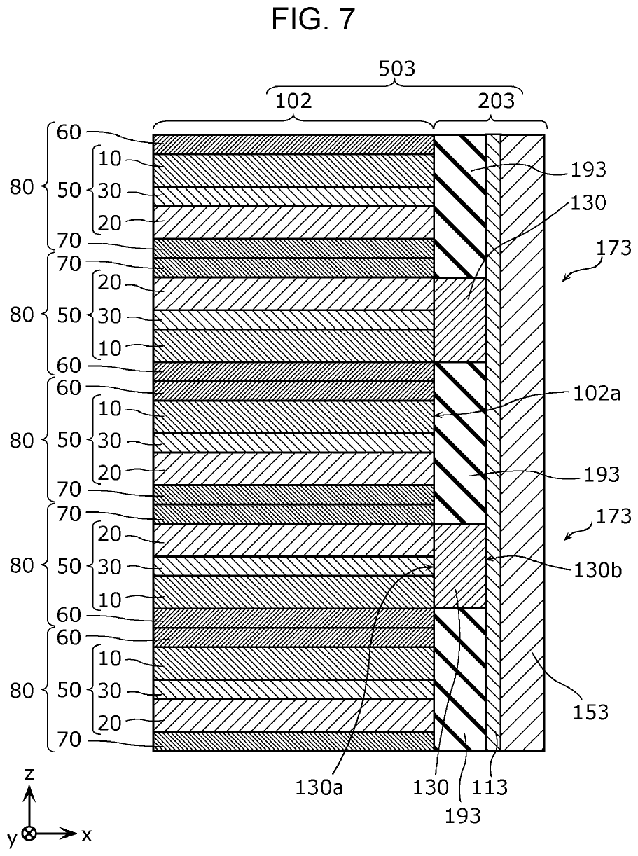

FIG. 7 is a cross-sectional view showing a schematic configuration of a battery 503 according to this modified example.

As shown in FIG. 7, the battery 503 is different from the battery 502 according to modified example 2 of the embodiment in including a structure 203 instead of the structure 200.

The structure 203 includes a plurality of reference electrode sections 173 and an insulating member 193.

In the structure 203, two or more reference electrode sections 173 among the plurality of reference electrode sections 173 include a common reference electrode 113 and a common reference electrode current collector 153. That is, the reference electrode 113 and the reference electrode current collector 153 are connected in two or more of the plurality of reference electrode sections 173. The reference electrodes 113 and the reference electrode current collectors 153 may be connected in all of the plurality of reference electrode sections 173.

The reference electrode 113 is in contact with second solid electrolyte layers 130 in two or more of the plurality of reference electrode sections 173. The reference electrode 113 has, for example, a region facing a side surface 102a of a solid-state battery section 102 with the second solid electrolyte layers 130 interposed therebetween and a region facing the side surface 102a with the insulating member 193 interposed therebetween.

The reference electrode current collector 153 is in contact with the reference electrode 113. The reference electrode current collector 153 covers the entire surface of the reference electrode 113 opposite to the second solid electrolyte layer 130 side, for example.

Thus, since the reference electrode 113 and the reference electrode current collector 153 are connected in two or more of the plurality of reference electrode sections 173, the structure 203 can be simplified and the mechanical strength of the structure 203 can be enhanced.

Note that either one of the reference electrode 113 and the reference electrode current collector 153 may not be connected and may be provided individually for each reference electrode section 173 as in the case of the reference electrode 110 or the reference electrode current collector 150 described above.

### Modified Example 4

Next, modified example 4 of the embodiment will be described. In the following description of the modified example, differences from the embodiment will be mainly described, and description of similarities will be omitted or simplified.

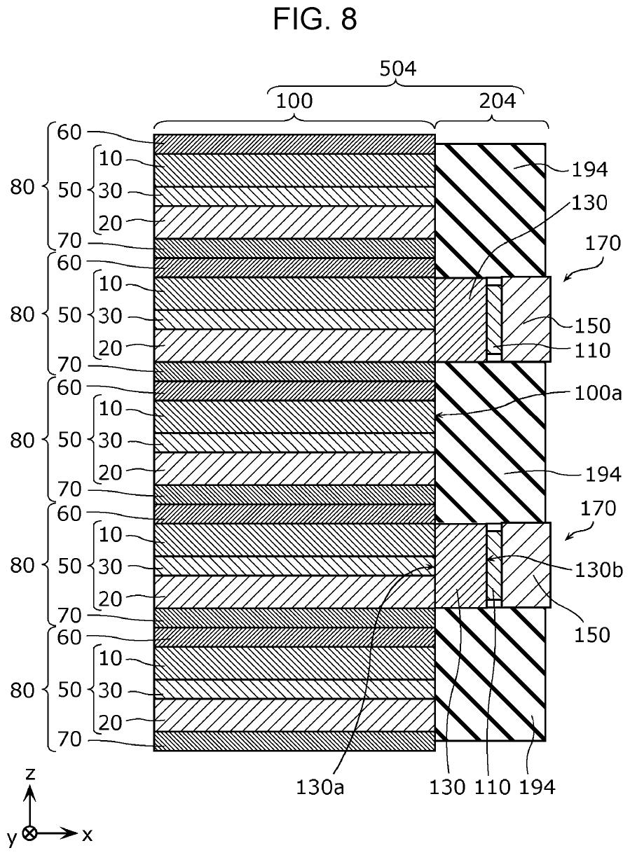

FIG. 8 is a cross-sectional view showing a schematic configuration of a battery 504 according to this modified example.

As shown in FIG. 8, the battery 504 is different from the battery 500 according to the embodiment in including a structure 204 instead of the structure 200.

The structure 204 includes a plurality of reference electrode sections 170 and an insulating member 194. The structure 204 has the same configuration as that of the structure 200 except that a width thereof in a laminating direction of a solid-state battery section 100 is smaller than that of the structure 200.

In plan view of a side surface 100a of the solid-state battery section 100, the structure 204 does not protrude beyond both ends of the solid-state battery section 100 in the laminating direction of the solid-state battery section 100. Also, the length of the structure 204 in the laminating direction of the solid-state battery section 100 is shorter than the length of the solid-state battery section 100 in the laminating direction of the solid-state battery section 100. That is, in plan view of the side surface 100a of the solid-state battery section 100, the entire structure 204 is located inside the both ends of the solid-state battery section 100 in the laminating direction. In this modified example, the outermost periphery of the structure 204 is formed of the insulating member 194 in plan view of the side surface 100a, and the entire insulating member 194 is located inside the both ends of the solid-state battery section 100 in the laminating direction. Thus, even when the solid-state battery section 100 is pressurized in the laminating direction for use, the structure 204 is less likely to interfere with the pressurization of the solid-state battery section 100. Thus, the reliability of the battery 504 can be improved. Furthermore, even when the solid-state battery section 100 is compressed in the laminating direction by the pressurization of the solid-state battery section 100 in the laminating direction, the structure 204 positioned on the inner side than the solid-state battery section 100 in the laminating direction of the solid-state battery section 100 is less likely to hinder the compression of the solid-state battery section 100. Thus, battery characteristics of the solid-state battery section 100 can be enhanced.

### OTHER EMBODIMENTS

The battery according to the present disclosure has been described above based on the embodiment and modified examples, but the present disclosure is not limited to these embodiment and modified examples. Variations of the embodiment and modified examples that would be conceived by those skilled in the art, and other forms constructed by combining some of the constituent elements in the embodiment and modified examples are also included in the scope of the present disclosure without departing from the gist of the present disclosure.

For example, in the above embodiments and modified examples, the structures 200, 201, and 204 have a plurality of reference electrode sections 170, but the present disclosure is not limited thereto. The structures 200, 201, and 204 may have one reference electrode section 170.

For example, the features of the structures in the above modified examples may be combined. For example, the arrangement of the second solid electrolyte layer 130 in the batteries 502 to 504 may be the same as in the battery 501. In the batteries 501 to 503, for example, the structure may be positioned inside both ends of the solid-state battery section 100 in the laminating direction.

In the solid-state battery section, for example, a plurality of power generating elements 50 may be connected by combining series connection and parallel connection.

Various changes, replacement, addition, omission, and the like can be made to the above embodiment and modified examples within the scope of claims or equivalent thereof.

The battery according to the present disclosure can be used for monitoring, design or development of electrodes, and the like. Also, the battery according to the present disclosure can be used for electronic devices, electric appliances, electric vehicles, and the like as a battery in which the electrical characteristics of the electrodes can be measured.

What is claimed is:

1. A battery comprising:
a solid-state battery section having a structure in which a plurality of power generating elements are laminated, each of which has a first electrode layer, a second electrode layer, and a first solid electrolyte layer positioned between the first electrode layer and the second electrode layer; and
a structure including a second solid electrolyte layer in contact with the power generating element so as not to be in contact with more than or equal to two power generating elements of the plurality of power generating elements on a side surface of the solid-state battery section, at least one reference electrode section facing the side surface of the solid-state battery section across the second solid electrolyte layer and including a reference electrode in contact with the second solid electrolyte layer, and an insulating member which is disposed so as to surround the second solid electrolyte layer in plan view of the side surface of the solid-state battery section and covers the side surface of the solid-state battery section.

2. The battery according to claim 1, wherein
the at least one reference electrode section includes a plurality of reference electrode sections,
a plurality of second solid electrolyte layers, which are the second solid electrolyte layers included in the plurality of reference electrode sections, respectively, are each in contact with different power generating elements among the plurality of power generating elements, and
the insulating member is arranged so as to surround each of the plurality of second solid electrolyte layers in plan view of the side surface of the solid-state battery section.

3. The battery according to claim 2, wherein
the insulating member is continuous, which is arranged so as to surround each of the plurality of second solid electrolyte layers.

4. The battery according to claim 2, wherein
the plurality of second solid electrolyte layers include two second solid electrolyte layers in contact with each of adjacent power generating elements among the plurality of power generating elements, and
the two second solid electrolyte layers do not overlap when viewed from the laminating direction of the solid-state battery section.

5. The battery according to claim 2, wherein
the plurality of second solid electrolyte layers have portions, respectively, that do not overlap with each other when viewed along the laminating direction of the solid-state battery section.

6. The battery according to claim 2, wherein
the number of the plurality of second solid electrolyte layers is more than or equal to four, and
the plurality of second solid electrolyte layers are arranged so as to form a plurality of rows extending along a direction not orthogonal to the laminating direction of the solid-state battery section on the side surface of the solid-state battery section.

7. The battery according to claim 1, wherein
the plurality of power generating elements are electrically connected in series and laminated.

8. The battery according to claim 1, wherein
the plurality of power generating elements are electrically connected in parallel and laminated.

9. The battery according to claim 2, wherein
the plurality of power generating elements are electrically connected in parallel and laminated, and
the reference electrodes in more than or equal to two of the plurality of reference electrode sections are connected.

10. The battery according to claim 2, wherein
the plurality of power generating elements are electrically connected in parallel and laminated,
the plurality of reference electrode sections each further include a reference electrode current collector in contact with the reference electrode, and
at least one of the reference electrodes in more than or equal to two of the plurality of reference electrode sections and the reference electrode current collectors in more than or equal to two reference electrode sections are connected.

11. The battery according to claim 1, wherein
the insulating member contains insulating resin.

12. The battery according to claim 1, wherein
in plan view of the side surface of the solid-state battery section, the structure does not protrude beyond both ends of the solid-state battery section in the laminating direction of the solid-state battery section.

13. The battery according to claim 12, wherein
a length of the structure in the laminating direction of the solid-state battery section is smaller than a length of the solid-state battery section in the laminating direction of the solid-state battery section.
